(19) United States
(12) Patent Application Publication
(10) Pub. No.: US 2010/0159114 A1
(43) Pub. Date: Jun. 24, 2010

(54) Method for tracking feed quality of forage crops stored in horizontal structures as the crop is removed

(76) Inventors: James Lawrence Yager, Fresno, CA (US); Jeffrey S. Roberts, Hudson, WI (US)

Correspondence Address: Jeffrey S. Roberts, President;Harvest Tec, Inc., P.O. Box 63, Hudson, WI, 54016, US

(21) Appl. No.: 12/317,285

(22) Filed: Dec. 23, 2008

(51) Int. Cl. A23K 1/00; G01S 1/00

(52) U.S. Cl. 426/636; 342/357.06

(57) ABSTRACT

A method for measuring the feed value of an amount of forage or grain removed from a horizontal storage structure by using the analyzed feed value from cores removed from the structure by tracking the movement of a removal device and referencing that position information to the three dimension position information of the cores that have been analyzed.

### CROSS REFERENCE TO RELATED APPLICATIONS.

This application is related to U.S. Pat. No. 7,425,924 B2 entitled. “A System and Method for Identifying Bales of Hay” filed Jan. 24, 2006, application Ser. No. 12/220,487 “A System and Method for Identifying Individual Loads of Chopped Forage in Storage”, filed Apr. 24, 2007, and a continuation application No. 342/357.13 entitled “A System and Method for Identifying Bales of Hay” filed Jul. 25, 2008.

### STATEMENT REGARDING FEDERALLY SPONSORED RESEARCH FOR DEVELOPMENT

Not Applicable.

### THE NAMES OF PARTIES ON A JOINT RESEARCH AGREEMENT

Not Applicable. description

### BACKGROUND

One common technique for harvesting forage crops is to chopping them with a mobile forage harvester in their field of origin and then transferring the forage to the site of storage which is normally horizontal structure such as a pit or bunker. The forage is then dumped in a pile at the intake to the pit or bunker and then normally spread and packed with tractor equipped with a front blade for the purpose of distributing the forage in two inch to ten inch thick horizontal layers so that it can be adequately packed for the exclusion of air. This packing and spreading method encourages fermentation of the forage for storage stability until it is later fed to livestock. The normal pit or bunker type of storage structure will hold between ten and five-hundred individual loads of forage originating from multiple fields, harvested at different times throughout the growing season for the forage crop.

The feeding properties, including digestibility and nutrient levels of the chopped forage varies from field to field, from area to area within an individual field, and from day to day during the harvest. Since a horizontal storage structure is filled from different fields and at different times, the feeding properties of the forage placed in different areas and layers in the storage structure can vary significantly. Since the forage is spread in horizontal layers, feeding properties vary between the horizontal layers and between areas in the horizontal structure depending on the placement of the loads that go into filling the structure. The typical horizontal storage structure contains ten to fifty layers of forage from individual toads delivered and spread into it, and therefore within a vertical cross section there is variation in feeding properties due to variations from load to load. Removal of the forage is normally done by stripping off the material in a vertical orientation, starting at the front of the structure and working back into the horizontal storage structure.

The production of milk from cows or the weight gain of beef cattle being fed the forage from these storage structures is dependent on the nutritional quality of the feed ration of which forage is usually the dominant component. If values of the feeding properties of forage are known, they can be balanced with other components of the ration fed. The typical method for monitoring the feeding properties of the forage is to pull samples from the stored forage, send them to a lab and then adjust the levels of the other components to maximize the value of the forage in a cost-effective way. The effectiveness of this system is limited by: the number and frequency at which the samples are taken; the location from which the samples are taken and how that is matched up to the actual forage as it is removed from the storage structure; and, the lag time associated with pulling the samples, sending them to a lab and waiting for the results.

In a prior invention, entitled “A system and method for identifying bales of hay”, the forage crop harvested in bales is tracked from the field by attaching an identification device to the bale as disclosed in the prior invention. This method of identification is not possible when the forage is chopped, transported and spread as loose material. In a subsequent invention entitled “A System and Method for Identifying Individual Loads of Chopped Forage in Storage,” individual loads of forage are tracked from the field to the horizontal storage structure mapped three-dimensionally and then monitored at the time they are removed for feeding. In this method, the feeding properties of the forage that are measurable as the crop is harvested are used to predict the feeding quality of the forage.

Three dimensional mapping using GPS technology, locating latitude, longitude and vertical position is possible and used in applications such as mining and aviation. Another technology widely used in agricultural crop production, is the coring of soils and analysis of the cored material based in field position and depth of the cored material. In the method that has been invented, three-dimensional mapping techniques are combined with coring techniques for forage stored in a horizontal structure to track the quality of forage as it is removed for feeding.

### BRIEF SUMMARY OF THE INVENTION

In the method that has been invented, a horizontal storage structure filled with chopped forage or grain, is core-sampled on a horizontal grid pattern using a coring tool operating on the top of the stored forage and extracting cores of the material in a vertical orientation. The cored material that is extracted is then analyzed for the properties that affect feeding quality. A horizontal grid is generated from the coring operation and matched to the vertical profile of the cored material yielding a three-dimensional grid and referenced to the analysis of the cores. When the chopped forage or grain is later removed for feeding, the removal device is equipped with a GPS receiver and the position of the chopped forage removed is tracked both horizontally and vertically. Using the three-dimensional grid generated by coring the storage structure, the feeding value of the removed forage can be calculated from the composite of the analysis performed on the appropriate cores.

### BRIEF DESCRIPTION OF SEVERAL VIEWS OF THE DRAWINGS

FIG. 1 shows the orientation of layers of individual loads in a typical horizontal storage structure.

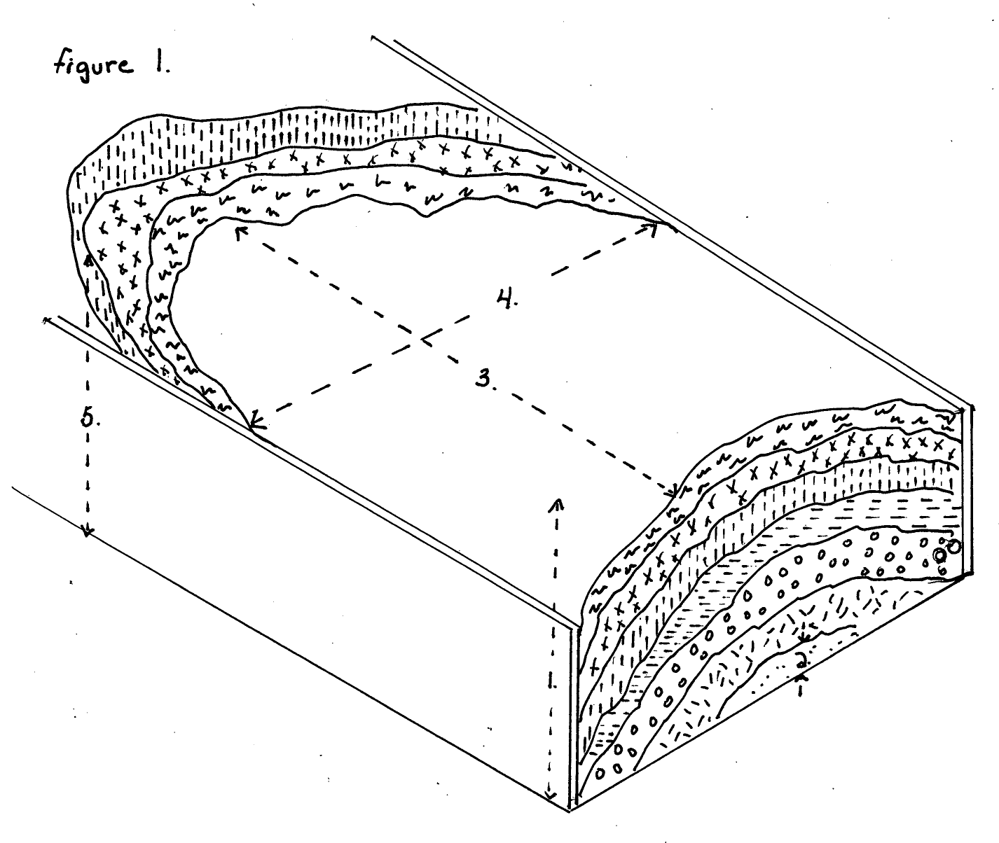

FIG. 2 shows a typical coring tool and grid layout used to create the 3-dimensional grid of the stored forage.

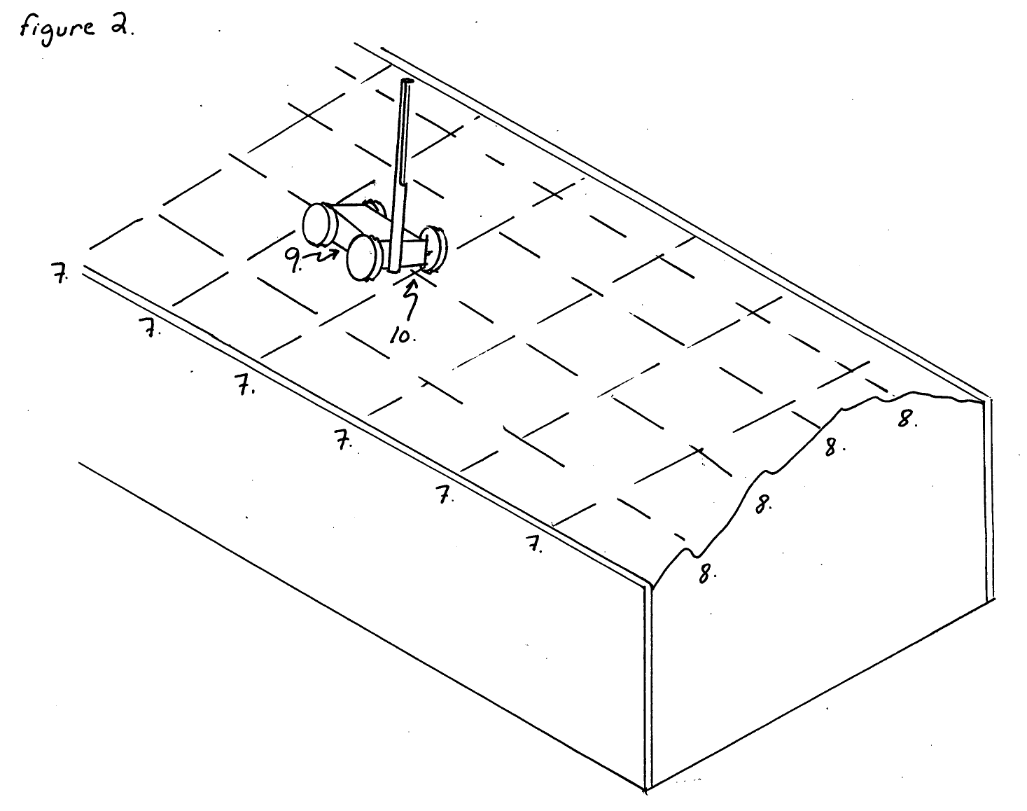

FIG. 3 shows according tool extracting the core for vertical profiling.

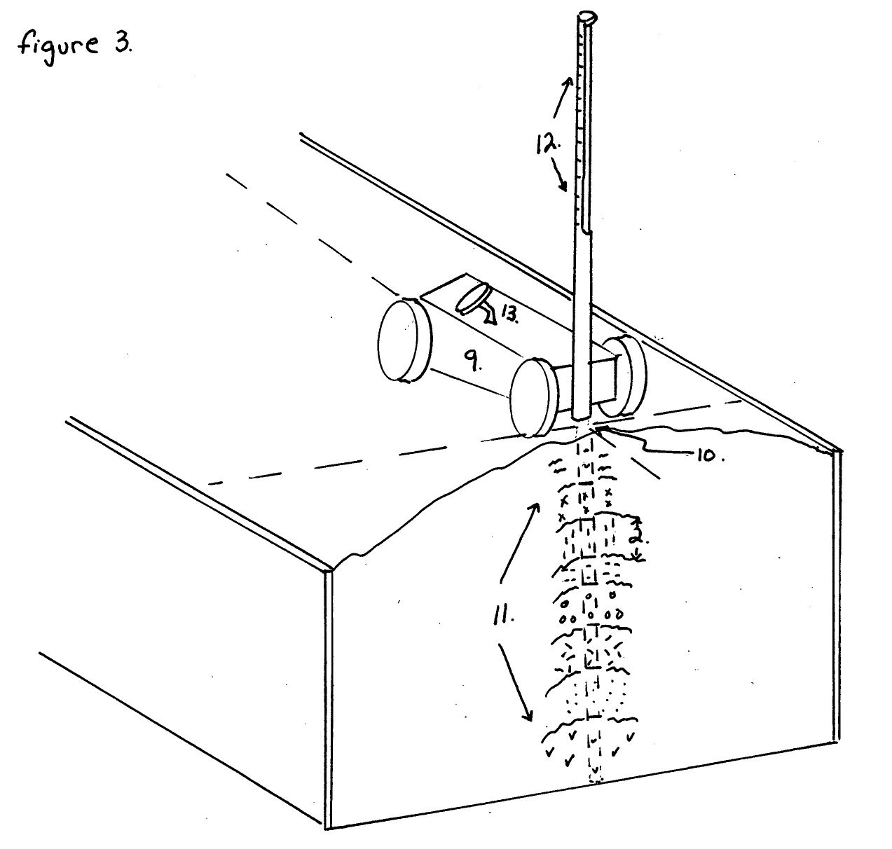

FIG. 4 shows a typical silage de-facer equipped with GPS horizontal and vertical sensors to track the removal of forage.

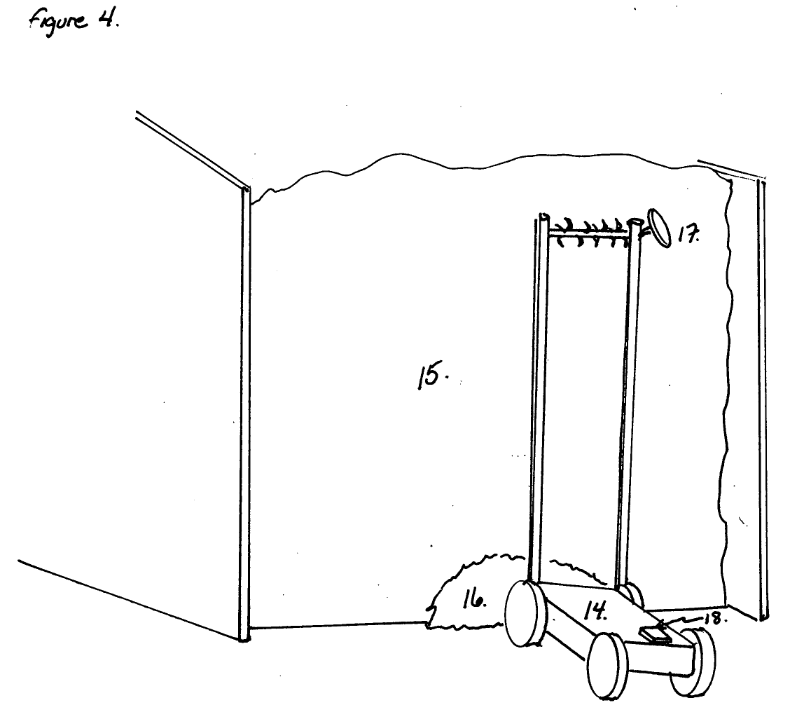

### DETAILED DESCRIPTION OF THE INVENTION

The method that has been invented can be used to identify the feeding quality of any forage or grain crop stored in horizontal structure. Forage crops that are commonly chopped and stored in horizontal structures include whole-plant corn silage, alfalfa hay silage, grass silage, ground ear corn, forage sorghum and small grain silages. Alternatively grain crops can be ground or processed to also be stored in horizontal structures.

Horizontal structures include piles, above-ground bunkers and in-ground pits. These storage structures are typically filled to a depth between ten and thirty feet 1-1. The forage material is brought to the storage structure from various fields of origin during the filling period in loads of material ranging from three to twenty tons. The individual loads are spread into the storage structure by an implement such as a tractor with a front blade resulting in a layer for each load between two and twelve inches thick 1-2 and extending into the storage structure ten to one hundred feet long 1-3 and ten to fifty feet wide 1-4 for each load. The filled storage structure will have a layered configuration with a structure of a maximum depth of ten to thirty feet having between ten and fifty layers of forage all with individual properties of feeding quality. The individual loads between three and twenty tons of forage are normally spread lengthwise 1-3 between ten and one hundred feet in storage structures that are between one hundred and five hundred feet in total length. Therefore the vertical layers in the front of the storage structure 1-1 are different that the layers in the middle or back of the structure 1-5.

After the vertical storage structure is filled to the top, a grid for core sampling is set up. The spacing of these grid lines going back into the structure 2-7 and across the structure 2-8 is determined by the tendency of the load layers to change going back into the horizontal storage structure. Normally the spacing of the grid lines going back 2-7 will be between one and ten feet so that sampling that is done will reflect a change in the load stratification as the material in the structure is later removed. The spacing of the grid lines 2-8 across the width of the structure is determined by the typical width of spreading of each load across the structure which is normally one-fifth to one-half of the total width of a structure. As an example, the grid lines across the width of a structure 2-8 for a sixty foot wide structure where the loads have been spread twenty feet wide would be twenty feet apart at ten feet, thirty feet and fifty feet across the structure.

After the grid lines are set, a vertical coring tool 2-9 is used to extract a core sample of the material in the storage structure at each grid line intersection 2-10. Coring tools technology has been developed primarily for sampling soil, with a two to eight inch core 3-11 is extracted from the soil by the tool and retained with a depth reference 3-12 for later analysis. Core sampling in this method has been employed for analysis of soil nutrients, for detection of soil contaminants, or for determining porosity of the soil material. In the method of this invention, coring forage stored in horizontal structures, the extracted core of stored feed 3-11 will be analyzed for feeding value. The position of the point at which the core is removed can be recorded in terms of latitude and longitude. This recording can most easily be done if the machine powering the coring device 3-9 is equipped with a GPS receiver 3-14 and with an associated memory to store the position information and a reference to the core removed 3-11. Alternatively, the horizontal grid lines can be laid out by measuring and marking the points where the grid lines going across intersect with the grid lines going back into the structure. After removal, each core is analyzed for feeding value. The core 3-11 is dissected at spacing between two and twenty inches determined by the typical thickness 3-2 of the layers spread into the structure. The feeding value is determined by conventional lab testing techniques that can measure moisture, protein, energy, trace mineral and other pertinent factors of the stored feed. Using the horizontal position information 3-10 and the vertical position information 3-12 a three dimensional grid representing the layered structure of the material in storage is generated. The feeding values are stored in memory and plotted by the position of their removal. In the case where the grid lines are recorded with a GPS receiver, the cores are referenced to their latitude and longitude. The depth profile 3-12 of the core is also plotted for each core taken, associating the feed value of the core with depth in the structure. The resulting three dimensional grid references the feed values from the core samples to the position they were extracted from in the structure.

Three-dimensional computer mapping software can be used to plot the position information from the grid and fill in the spaces between the grid points resulting in a three-dimensional map.

Forage stored in horizontal structures is normally removed from the structure stripping it vertically, starting at the front and working back, removing all of the material along a vertical plane. A common means to remove the forage is with a silage de-facer 4-14 that digs out two to six inches of material as it is worked up and down on the vertical face of the stored forage 4-15. As the forage is dug out by the de-facer, the result is a loose pile of forage at the base of the structure 4-16 that is made up of the material dug out above it. In the method that has been invented, the de-facer 4-14 is equipped with a GPS receiver 4-17 that tracks the position of the removal mechanism of the de-facer. The GPS receiver tracks three factors: latitude, longitude and elevation. The position sensor on the defacer 4-17 is connected to a data processor with a memory 4-18 that provides for a marker to be set in memory when the defacer moves to a position up against the face of the stored feed. After the marker is set, the memory records the movement of the defacer by receiving a continuous signal from the GPS receiver 4-17. The processor 4-18 located on the defacer or in an alternate location can use the movement to calculate a volume taken from a specific area of the horizontal storage structure.

Alternatively, a scoop-type loader bucket can be used for removal of the stored forage. In this embodiment, the bucket is also equipped with a position sensor for determining latitude, longitude and depth. The tracking of the bucket is done by setting a position marker in memory as the bucket is placed against the face of the horizontal storage structure. The position sensor will monitor the movement of the bucket forward into the structure and disregard movement away from the face, as the bucket makes repeated back and forth passes to losses the material in the storage structure. For use of the scoop-type bucket in tracking material removal, it is important to keep a straight vertical face on the stored forage or multiple markers need to be set in memory. The volume and position information is stored in file format directly on a removable storage memory device or duplicated to a removable storage memory device or sent by radio signal to a remote memory device.

The volume and position information file, when taken from the removal device is then cross referenced to the feeding value analysis that has been mapped three-dimensionally as generated by analysis of the cores 3-11. A composite value of the feed removed is calculated by a data processor and this value can be used for adjusting the ration fed to the livestock consuming the feed.

What is claimed:

1. A method of measuring the feeding properties of forage or grain stored in a horizontal structure by: taking core samples of the forage or grain from multiple locations recording the position for the point at which the core is extracted; recording a depth profile of the core removed; creating a three-dimensional grid of a horizontal storage structure; analyzing the feed value of the extracted cores; associating the results of core sampling to the three-dimensional grid; tracking the removal of forage or grain on a removal device; associating the feed value analysis from the three-dimensional grid to the composite amount of feed removed.

2. A method as in claim one where the feed removal is accomplished with a scoop bucket that is equipped with a position sensor that tracks the horizontal and vertical movement of the bucket inward and up and down from a point set as the starting point for the bucket as it removes forage or grain from the structure.

3. A method as in claim one where the feed removal is accomplished with a de-facing implement that is equipped with a position sensor for latitude, longitude and vertical position that tracks movement inward and up and down from a point set as the starting point for the defacer as it removes forage or grain from the structure.

4. A method as in claim one where three-dimensional mapping software is used to connect the grid points for the cores extracted and then the map is used for determining the amount of forage or grain removed from the horizontal structure.

5. A method as in claim one where the horizontal position information for the cores is measured by a GPS location device.

6. A method as in claim one where the horizontal and vertical position information of a removal device is tracked using a three-dimensional GPS location device.
